(19) United States
(12) Patent Application Publication
(10) Pub. No.: US 2014/0215008 A1
(43) Pub. Date: Jul. 31, 2014

(54) NETWORK METHOD AND APPARATUS

(71) Applicant: IMAGINI HOLDINGS LIMITED, London (GB)

(72) Inventors: Charles Wiles, London (GB); Filippo Diotalevi, London (GB); Ashwin Desikan, London (GB); Tomas Cervenka, London (GB)

(73) Assignee: Imagini Holdings Limited, London (GB)

(21) Appl. No.: 13/789,296

(22) Filed: Mar. 7, 2013

(30) Foreign Application Priority Data
Jan. 30, 2013 (GB) 1301659.7

(51) Int. Cl. H04L 29/08

(52) U.S. Cl. CPC H04L 67/10
USPC 709/217

(57) ABSTRACT

A network apparatus and method are described in which a request for content from a user device is redirected based on a profile of the user of the user device. For example, an apparatus is disclosed, which may provide a server for use in a network. This apparatus comprises a data store configured to store a plurality of webpage identifiers each identifying a different webpage of a set of webpages; a communication interface configured to receive a request for content to be provided at a user device; and a controller configured to: determine a user identifier of a user of the user device based on the received request; obtain a user profile based on the user identifier; select one of the stored webpage identifiers based on the user profile and a direction model; and redirect the request according to the selected webpage identifier. Examples of the disclosure also relate to client side and server side scripting which perform comparable functionality, and to methods of responding to search queries which select and/or modify search results based on a user's profile.

### CROSS-REFERENCE TO RELATED APPLICATIONS

The present application claims priority to co-pending Great Britain patent application number 1301659.7, entitled “NETWORK METHOD AND APPARATUS”, filed Jan. 30, 2013, the disclosure of which is hereby incorporated herein by reference.

### TECHNICAL FIELD

The present disclosure relates to methods and apparatus for use in communications networks, more particularly the present disclosure relates to methods and apparatus for controlling the interaction of user devices with servers that provide content to those user devices over a network.

### BACKGROUND OF THE INVENTION

It is known that internet servers providing websites of user content must serve user requests by transmitting content across a network. Each request places a burden on the content servers, and on the network.

The number of internet users has increased enormously in recent years, and the advent of handheld devices with increasing communications bandwidth and processing power, and the demand for multimedia content places an increasing burden both on servers which must provide the content, and on the networks which support the communication.

Communications protocols have been developed to provide increased bandwidth, and servers having increased processing power have been provided to try to address these issues. However, the inventors in the present case have identified a problem that users will frequently, by force of habit, or as a result of lack of knowledge, routinely elect to browse from a generic page of a website, or “landing page”, to a more specific page comprising the content which in fact they were looking for at the outset. As shown in the schematic timing diagram of FIG. 1, the process of browsing to find the content required by the user may entail a series of requests made of the server across the network. Each request must be responded to by the server sending a content rich (bandwidth heavy) page across the network. Thus, each request places a processing burden on the content server, and a bandwidth load on the network.

The inventors in the present case have identified a new way to control browsing activity to reduce this network load, and the processing burden placed on content servers.

### BRIEF SUMMARY OF THE INVENTION

An aspect of the present disclosure provides an apparatus comprising: a data store configured to store a plurality of webpage identifiers each identifying a different webpage of a set of webpages; a communication interface configured to receive a request for content to be provided at a user device; and a controller configured to: determine a user identifier of a user of the user device based on the received request; obtain a user profile based on the user identifier; select one of the stored webpage identifiers based on the user profile and a direction model; and redirect the request according to the selected webpage identifier. FIG. 2 shows one way in which this can reduce network load by enabling a redirection server to apply a simple text rule to a narrow bandwidth request of typically only a few bytes of data, and respond with a redirect message of comparable (small) size to cause a user to be directed to content tailored for that user.

In some examples each webpage identified by the set comprises some content that is common to all of the webpages of the set, and a combination of content elements that is different from the combination of content elements of the other webpages of the set. In other examples the webpages may form part of the same generic group, but differ in their specific detail. For example the semantic content of the webpages of the set may share a common theme. In some examples each webpage identifier of the set may identify a resource associated with a selected domain, or with a selected IP address or group of IP addresses.

There is also provided an apparatus comprising: a data store configured to store a plurality of webpage identifiers each identifying a different webpage of a set of webpages; a communication interface configured to receive a request for content to be provided at a user device; and a controller configured to: determine a user identifier of a user of the user device; obtain a user profile based on the user identifier; select one of the stored webpage identifiers based on the user profile and a direction model; and redirect the request according to the selected webpage identifier.

The controller may be configured to specify a webpage identifier based on the direction model and an attribute value of the user profile. The controller may be configured to select the direction model from a plurality of stored direction models based on a webpage identifier in the received request for content. The direction model may comprise a plurality of predictors, wherein each predictor is configured to provide a predicted rating for a corresponding one of the stored webpage identifiers. Each predictor may be configured to provide a predicted rating for a corresponding webpage identifier based on at least one attribute value of the user profile. Each predictor may provide at least one of an estimate of the rating and a measured rating, corresponding to each of the at least one attribute values.

At least one of the predictors may comprise both an estimate of the rating and a measured rating, and the controller may be configured to determine the predicted rating based on a combination of the estimate of the rating and the measured rating. The controller may be configured to combine the estimate of the rating with the measured rating according to a selected weighting. For example, the controller can be configured to determine the weighting based on a number of users that have visited a webpage identified by the webpage identifier associated with the at least one predictor. For example, the controller can be configured so that the weighting of the measured rating increases as a function of the number of users that have visited the webpage identified by the webpage identifier associated with the at least one predictor.

Selecting one of the stored webpage identifiers may comprise comprises selecting based on the predicted ratings.

The controller may be configured to receive an indication of the user's interaction with a webpage identified by the selected webpage identifier, and to modify the direction model based on the received indication. Receiving an indication may comprise receiving a second request for content from the user device indicating that the user has requested content from one of a second selected set of webpages.

There is also provided an apparatus comprising: a data store configured to store a plurality of webpage identifiers each identifying a different webpage of a set of webpages; a communication interface configured to receive a request for content to be provided at a user device; and a controller configured to: determine a user identifier of a user of the user device; select one of the stored webpage identifiers; redirect the request according to the selected webpage identifier; receive, via the communication interface, information describing the user's interaction with a webpage identified by the selected webpage identifier; obtain a user profile based on the user identifier; determine a direction model associated with the set of webpages based on the user profile and the information describing the user's interaction with the webpage. Selecting a webpage identifier may comprise at least one of: selecting according to a defined sequence of webpage identifiers; selecting according to a random process; and selecting according to a probability distribution. The controller may be configured to store the direction model, wherein determining the direction model comprises updating the stored direction model.

The direction model may comprise a plurality of predictors, and each predictor may be configured to provide a rating for a corresponding one of the stored webpage identifiers. For example, each predictor may be configured to provide a rating for a corresponding webpage identifier based on at least one attribute value of the user profile. The controller may be configured to update the stored direction model by updating the predictor associated with the selected one of the stored webpage identifiers, for example based on a number of users that have visited a webpage identified by the selected one of the stored webpage identifiers.

Selecting one of the stored webpage identifiers may comprise selecting based on a number of users that have visited each of the webpages identified by the stored webpage identifiers. The controller may be configured to select one of the stored webpage identifiers based on an attribute value of the user profile and a number of users having a user profile comprising the attribute value that have visited each webpage of the set. The controller may be further configured such that, in the event that a selected number of requests for content have been redirected, the controller is configured to select one of the stored webpage identifiers based on the user profile and a direction model; and to redirect the request according to the selected webpage identifier.

The controller may be configured to determine the user identifier based on the received request. The received request may comprise a cookie, and the controller can be configured to determine the user identifier from the cookie.

The data store may be configured to store plurality of said sets of webpages, and the controller is configured to select one of the plurality of sets based on the received request.

The set of webpages may comprise a default webpage, and a plurality of alternative webpages, and the controller may be configured to determine a first rating associated with the default webpage; determine a second rating associated with a selected alternative webpage; and redirect the request to either the selected alternative page or to the default page based on the first and second ratings.

The first and second ratings can be determined by direction models associated with the default and alternative webpages respectively. The direction models can be configured so that the ratings correlate with a bounce rate associated with respective webpages of the set, for example, the direction models may comprise Bayesian predictors of the bounce rate.

In an aspect there is provided an apparatus comprising: a data store configured to store a plurality of webpage identifiers each identifying a different webpage of a set of webpages, a communication interface configured to receive a search query from a user device; and a controller configured to: determine a user identifier identifying a user of the user device based on information associated with the search query; identify a list of search results based on the search query and the user identifier; determine whether the list of search results comprises a result associated with the stored plurality of webpage identifiers; and end the list of search results to the user device, wherein the controller is further configured such that, in the event that it is determined that the list of search results comprises a result associated with the stored plurality of webpage identifiers, the controller is arranged to: obtain a user profile based on the user identifier; obtain a direction model associated with the set of webpages; select a webpage identifier from the stored plurality of webpage identifiers based on the user profile and the direction model; and amend the list of results by adding the selected webpage identifier to the list of results before sending the list of results to the user device.

The controller may be configured to: receive a request for content received from the user device, wherein the request for content indicates that one of the webpages identified by the set of webpage identifiers has been sent to the user device, and to modify the direction model based on the request for content.

The direction model may be configured to specify a webpage identifier based on an attribute of the user profile. The direction model may comprise a predictor for each webpage identifier of the set to provide a rating for each webpage of the set based on the user profile, and the controller may be configured to select the webpage identifier based on the ratings.

There is also provided a method comprising; receiving a request for content to be provided at a user device; and determining a user identifier of a user of the user device; obtaining a user profile based on the user identifier; selecting a webpage identifier from a plurality of stored webpage identifiers based on the user profile and a direction model, wherein each of the stored webpage identifiers identifies a different webpage of a set of webpages; and redirecting the request according to the selected webpage identifier.

Selecting one of the stored webpage identifiers may comprise selecting a webpage identifier based on the direction model and an attribute value of the user profile. The direction model may be selected from a plurality of stored direction models based on a webpage identifier in the received request for content. The direction model may comprise a plurality of predictors, wherein each predictor is configured to provide a predicted rating for a corresponding one of the stored webpage identifiers, the method comprising determining a predicted rating for each of the stored webpage identifiers based on the predictors and at least one attribute value of the user profile.

The method may comprise receiving an indication of the user's interaction with a webpage identified by the selected webpage identifier, and modifying the direction model based on the received indication. Receiving an indication may comprise receiving a second request for content from the user device indicating that the user has requested content from one of a second selected set of webpages.

There is also provided a method comprising: receiving a first network message comprising a request for content to be provided at a user device; and determining a user identifier of a user of the user device; selecting a webpage identifier from a stored plurality of webpage identifiers each identifying a different webpage of a set of webpages; sending a second network message to the user device to redirect the request according to the selected webpage identifier; receiving information describing the user's interaction with a webpage identified by the selected webpage identifier; obtaining a user profile based on the user identifier; determining a direction model associated with the set of webpages based on the user profile and the information describing the user's interaction with the webpage.

The method may comprise storing the determined direction model. Determining the direction model may comprise updating the stored direction model. The direction model may comprise a plurality of predictors, wherein each predictor is configured to provide a rating for a corresponding one of the stored webpage identifiers. Each predictor can be configured to provide a rating for a corresponding webpage identifier based on at least one attribute value of the user profile.

Updating the stored direction model may comprise updating the predictor associated with the selected one of the stored webpage identifiers, for example by updating the predictor based on a number of users that have visited a webpage identified by the selected one of the stored webpage identifiers.

The method may comprise determining the user identifier based on the first network message. The method may comprise selecting one of a plurality of stored sets of webpage identifiers based on the received request.

The set of webpages may comprise a default webpage, and a plurality of alternative webpages, and the method may comprise: determining a first rating associated with the default webpage; determining a second rating associated with a selected alternative webpage; and redirecting the request for content to either the selected alternative page or to the default page based on the first and second ratings.

There is also provided a method comprising: receiving a network message comprising a search query from a user device; determining a user identifier identifying a user of the user device based on information associated with the search query; identifying a list of search results based on the search query; determining whether the list of search results comprises a result associated with a stored plurality of webpage identifiers; sending the list of search results to the user device; and, in the event that it is determined that the list of search results comprises a result associated with the stored plurality of webpage identifiers: obtaining a user profile based on the user identifier; obtaining a direction model associated with the set of webpages; selecting a webpage identifier from the stored plurality of webpage identifiers based on the user profile and the direction model; and amending the list of results by adding the selected webpage identifier to the list of results before sending the list of results to the user device.

The method may comprise receiving a second network message indicating that the webpage identified by the selected webpage identifier has been sent to the user device; and modifying the direction model based on the second network message. The direction model may comprise a predictor for each webpage identifier of the set to provide a rating for each webpage of the set based on the user profile, the method comprising selecting the webpage identifier based on the provided ratings.

The set of webpages may comprise a default webpage, and a plurality of alternative webpages, the method comprising determining a first rating associated with the default webpage; determining a second rating associated with a selected alternative webpage; and selecting the alternative page or the default page based on the first and second ratings.

### BRIEF DESCRIPTION OF THE DRAWINGS

Embodiments of the disclosure will now be discussed, by way of example only, with reference to the accompanying drawings in which:

FIG. 1 is a schematic timing diagram indicating an exchange of requests and responses associated with internet browsing;

FIG. 2 is a second schematic timing diagram indicating an exchange of requests and responses associated with internet browsing;

FIG. 3 is a diagram of a communications computer network;

FIG. 4 is a schematic diagram of apparatus for use in the network of

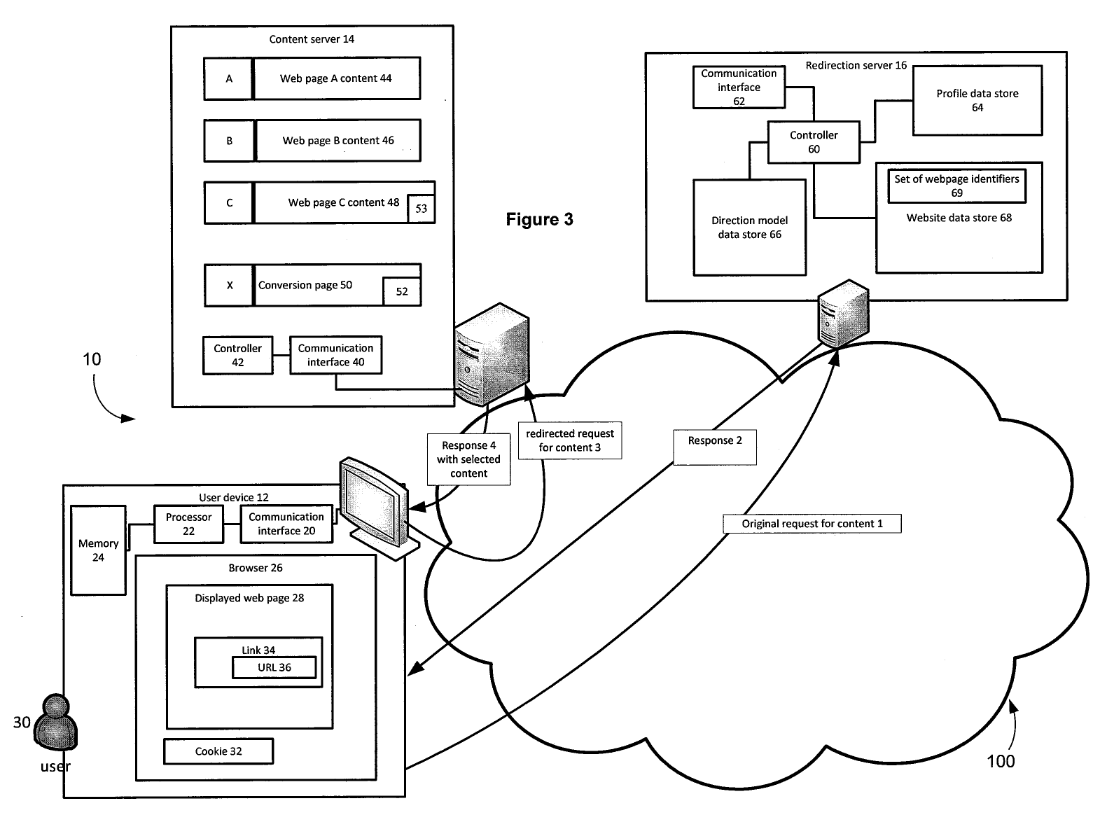

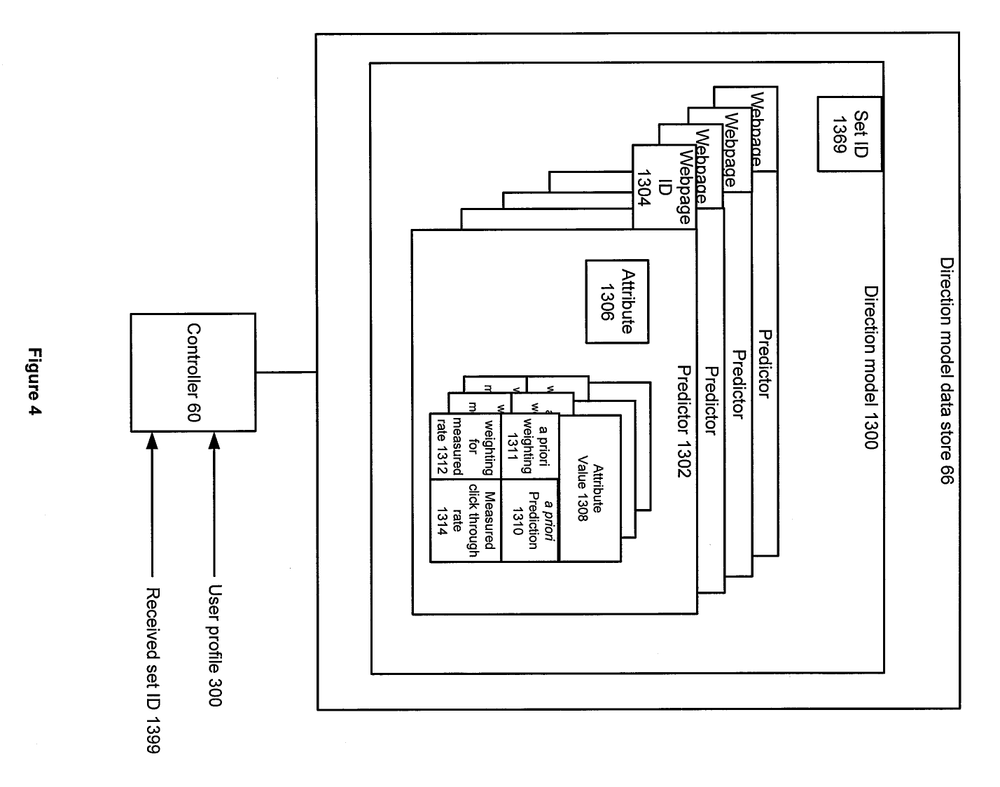

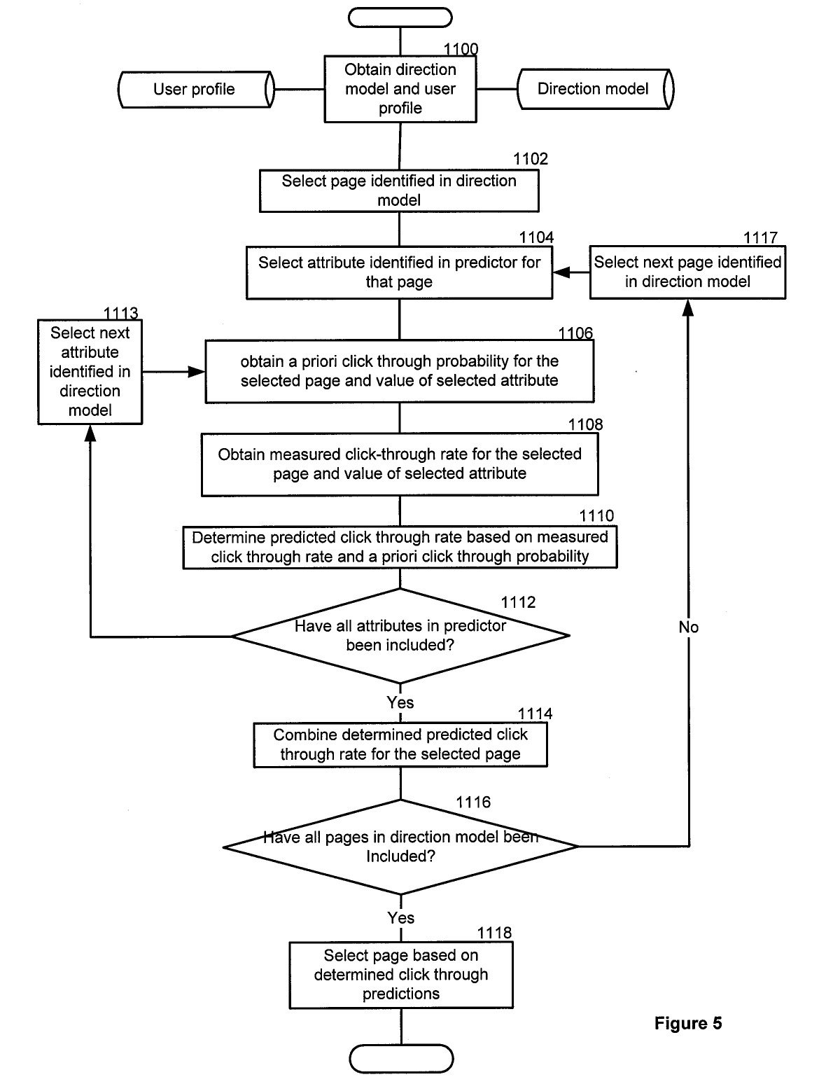

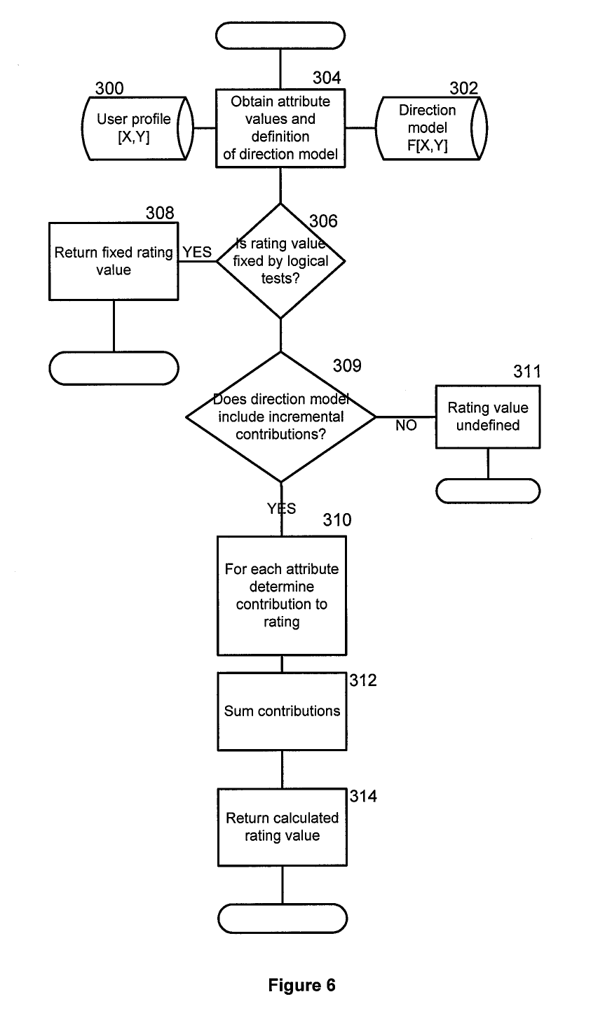

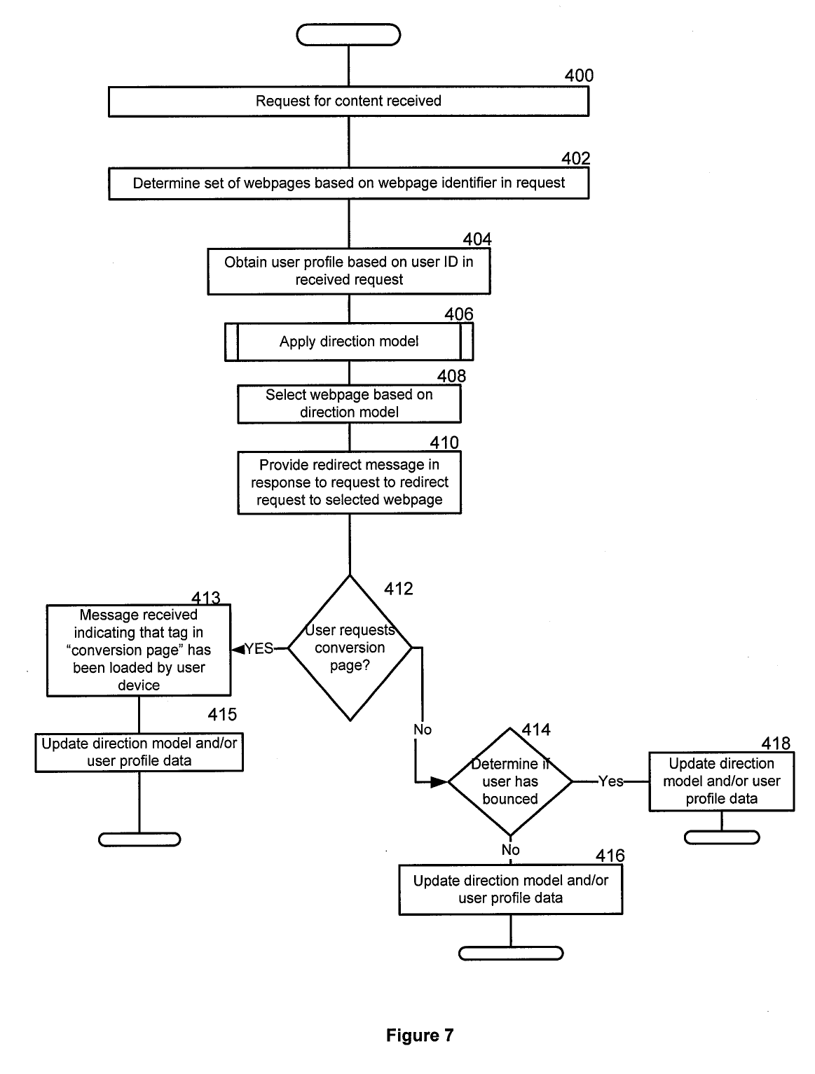

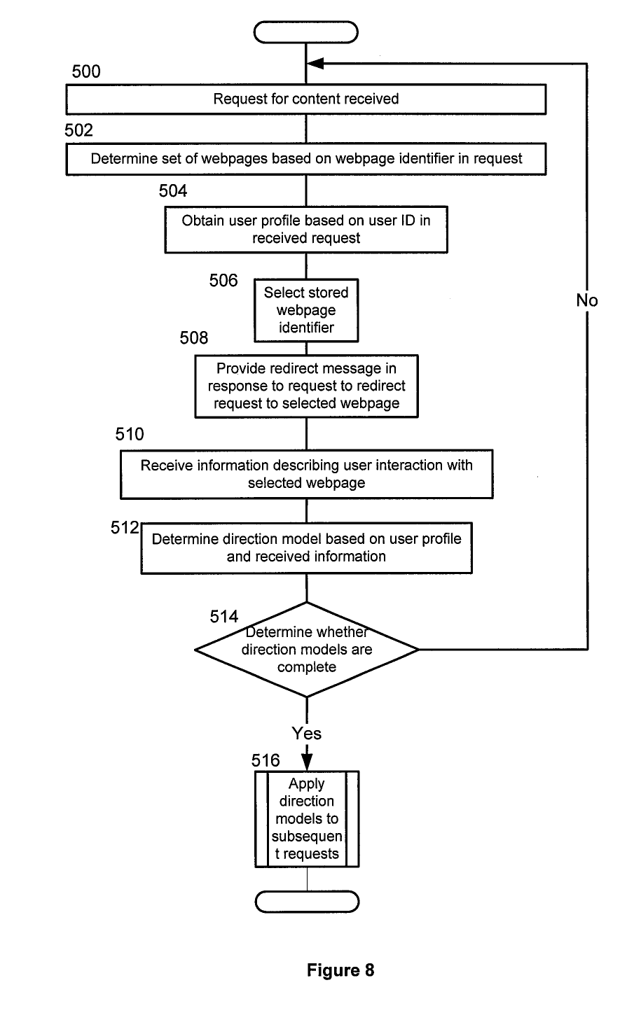

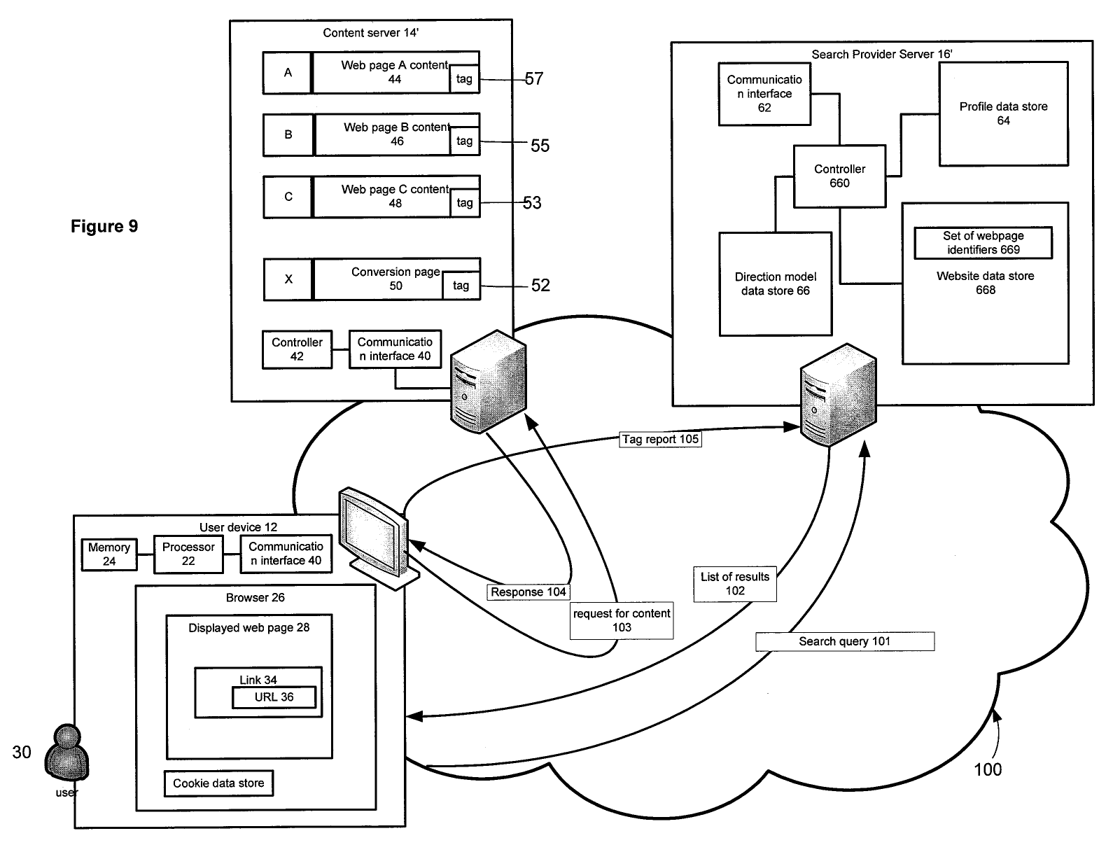

FIG. 3;

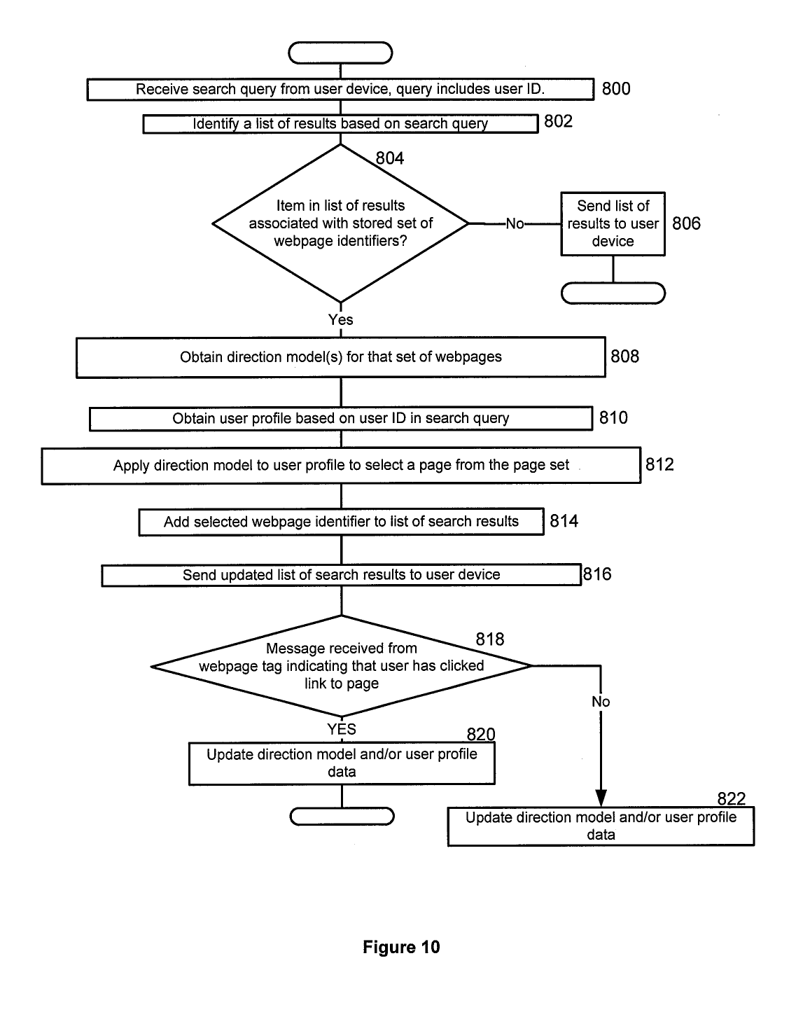

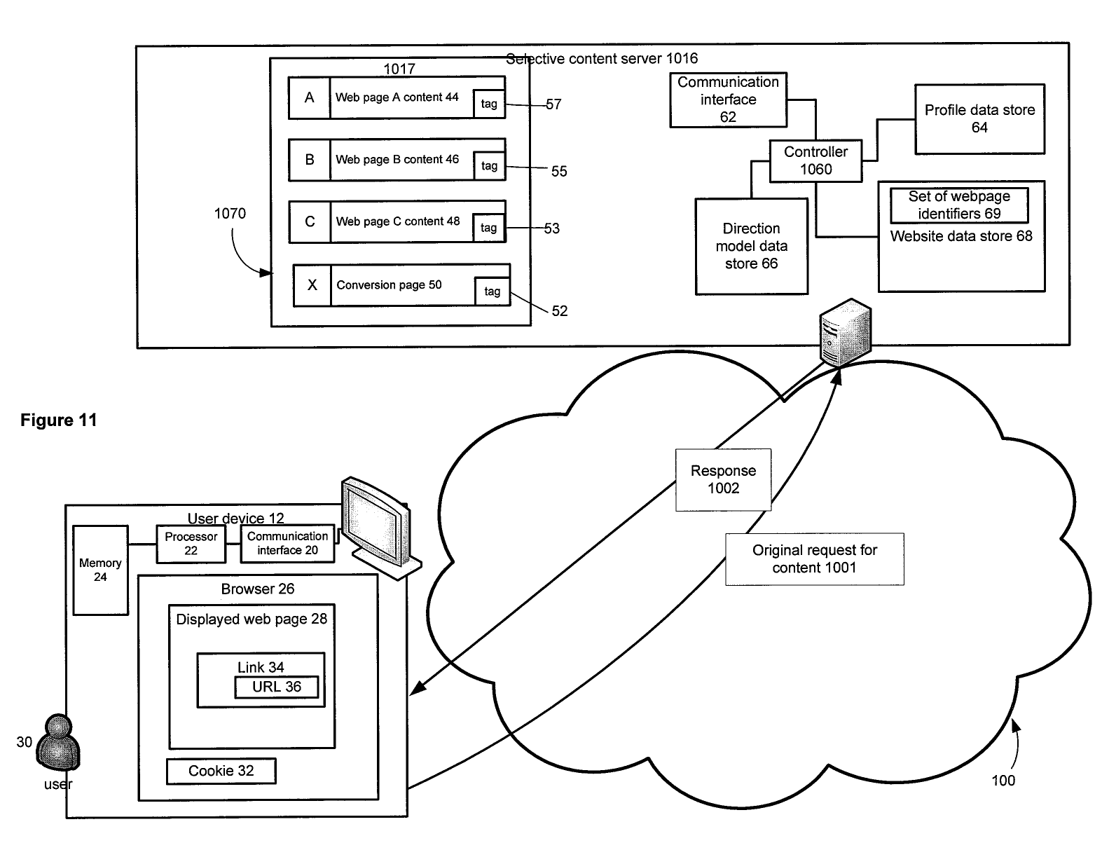

FIG. 5 is a flow diagram illustrating one way of determining a rating for a webpage which may be used by the apparatus of FIG. 4;

FIG. 6 is a flow diagram illustrating one way of determining a rating for a webpage which may be used by a redirection server in the network of FIG. 3;

FIG. 7 is a flow diagram illustrating one method of operating a server in the network of FIG. 3;

FIG. 8 illustrates another method of operating a server in the network of

FIG. 3;

FIG. 9 is a diagram of a second computer network;

FIG. 10 is a flow diagram illustrating one method of operating a server in the communications network of FIG. 9; and

FIG. 11 is a diagram of a third computer network.

### DETAILED DESCRIPTION OF THE INVENTION

When a user browsing the internet follows a link on a webpage, embodiments of the disclosure direct that user to a selected one of a set of webpages. The set of webpages may share some generic characteristic whilst the particular page of the set to which the user is directed is selected based on a user profile associated with that user. Examples of the disclosure also find application in the selection and presentation of search results in response to a user query.

FIG. 3 shows a network in which a user's requests for content are redirected according to their user profile. In FIG. 3, a network 10 comprises a user device 12 coupled to communicate with a content server 14 and a redirect server 16 over the internet 100.

The user device 12 comprises a communication interface 20, a processor 22, and a memory 24. The user device 12 also comprises an internet browser 26, e.g. a computer program configured to operate the communication interface 20, the processor 22 and the memory 24 to request and receive content such as webpages over the internet 100. The memory 24 is operable to store a cookie 32 which may be read by the browser 26 and stored in the browser 26 during operation. The browser 26 is operable to read and write to and from the memory 24 to perform operations on the cookie, and to perform operations which comprise including the cookie 32 in messages sent to and from the browser 26. Thus, the browser 26 is operable to include the cookie 32 in requests for content sent to the redirection server 16 and to the content server 14. The browser 26 is also configured to provide a display to a user based on data included in received webpages 28. The webpage 28 includes a link 34 for display to the user 30, and the link 34 includes a webpage identifier 36 comprising a URL that identifies the redirection server 16, and information identifying a set of webpages 69.

The redirection server 16 comprises a controller 60, a communication interface 62, a profile data store 64, a direction model data store 66, and a website data store 68.

The profile data store 64 is operable to store a plurality of user profiles. Each of the user profiles comprises a plurality of attribute values, each describing an attribute of a user 30 such as their gender, age, location, browser application type, income, credit risk, the history of websites they have visited, habits, or preferences etc.

The website data store 68 is operable to store at least one set of webpage identifiers 69. Each webpage identifier of the set 69 is configured to identify one webpage stored on the content server 14.

The direction model data store 66 is operable to store a plurality of direction models including a direction model for each webpage identifier of the set 69 stored in the website data store 68. Each direction model is operable to be used by the controller 62 to select a webpage identifier from a selected set of webpage identifiers 69 based on the user profile. To enable this selection the direction model may be configured to provide a rating based on the attribute values of the user profile. The contribution made by each attribute of the user profile to the rating provided by the direction model is defined by the direction model. Examples of a direction model are described in more detail below with reference to FIG. 4, FIG. 5, and FIG. 6.

The content server 14 comprises a communication interface 40 and a controller 42, and data storage for storing a plurality of webpages 44, 46, 48, 50. The content server 14 is configured to receive requests for content, and to respond to those requests by sending a webpage identified in the request to the requesting device 12.

Each of the stored webpages 44, 46, 48, 50 is identified by a respective webpage identifier A, B, C, X. A set of these webpages 44, 46, 48 comprise some content that is common to all webpages of the set, and a combination of content elements that is different from the combination of content elements of the other webpages of the set.

At least one webpage 48, 50 of the stored webpages 44, 46, 48, 50 comprises a tag 52, 53. The tag 52, 53 is configured so that, in order to load the webpage comprising the tag on a user device 12, the user device 12 is caused to send a request to a server identified by that tag 52, 53. This request comprises a user identifier, such as a cookie which may be provided by the cookie 32 or by another cookie.

In operation, the browser 26 displays a webpage 28 to a user 30 including the link 34.

In response to the user 30 selecting the link 34, the browser 26 is configured to generate a request for content using the webpage identifier 36 associated with the selected link 34. The request for content 1 includes an identifier of the requested content, the server which is to provide the content. In the example illustrated in FIG. 3, the webpage identifier 36 is configured to enable the browser 26 to generate a request 1 for content from the set of webpages 69 from the redirection server 16.

The webpage identifier 36 may be of the form:
www.redirectionserver16.com/set of webpages 69

A first part of the webpage identifier in the original request for content 1 identifies the redirection server 16 as the host to which a request should be transmitted, and a second part of the webpage identifier identifies the set of webpages 69 as content to be requested. In this example, the request for content formulated by the user device is configured to get the content identified by set of webpages 69 from the host www.redirectionserver16.com.

The user device 12 then sends the generated request 1 to the redirection server 16 over the internet 100. The controller 60 of the redirection server 16 receives the request 1 via the communication interface 62 and reads the second part of the webpage identifier 36 from the request 1. Based on this second part of webpage identifier, the controller selects the direction model associated with the set of webpages 69 from the direction model data store 66.

The controller 60 also reads the cookie 32 received with the request 1 to obtain a user identifier to identify the user 30 of the user device 12. The controller 60 then uses the user identifier to obtain the user's profile from the profile data store 64. The controller 60 then applies the selected direction model to the user profile to determine a rating for each webpage of the set 69. Based on the determined ratings, the controller 60 selects a webpage identifier from the set. For example, based on the determined ratings, the controller may select the webpage identifier that identifies webpage A stored on content server 14.

The controller 60 then provides a response 2 to be transmitted to the user device 12 from which the request was received. The response is configured to cause the user device 12 to redirect the request for content, and comprises the webpage identifier selected from the set 69 which identifies the resource to which the request is to be redirected. Thus, this response 3 redirects the original request 1 to cause a second (redirected) request 3 to be sent to the content server 14.

In response to receiving the second request for content 3, the content server 14 returns webpage identified by the new webpage identifier (in this example data for webpage A) to the requesting user device 12. In response to receiving the webpage data, the browser 26 processes the webpage data to display the webpage on the user device 12 for viewing by the user 30.

This may enable the redirection sever to predict a subset of some generic content which will best satisfy a generic user request, thereby reducing unnecessary network traffic and reducing the communications burden on the network 10.

An example of a direction model will now be described with reference to FIG. 4 and FIG. 5. FIG. 4 illustrates a direction model data store 66 and a controller 60 such as may be used in the redirection server of FIG. 3. FIG. 5 is a flow chart illustrating one way of determining a rating for a webpage using the apparatus of FIG. 4.

In the examples of FIG. 4 and FIG. 5, a direction model 1300 comprises a predictor 1302 for each webpage 1304 of a set 1369. Each predictor 1302 is configured to determine a rating for each webpage 1304 of a set 1369. In these examples, that rating comprises a predicted click-through rate.

The click-through rate can be defined as the number of users who, after visiting a page then subsequently visit one of a selected set of other pages (e.g. “click-through” to those pages). Typically that set of other pages comprise other pages of the same domain, but any selected set of webpages may be used to determine a click-through.

In FIG. 4 a direction model data store 66 comprises memory configured to store a direction model 1300. The direction model is associated with a set identifier 1369, which associates the direction model 1369 with a particular set of webpages (e.g. the set of webpages identified by the set 69 of FIG. 3).

The direction model 1300 comprises a plurality of predictors 1302. Each predictor 1302 is associated with a webpage identifier 1304. Each predictor 1302 stores an association between an attribute 1306 and, for each value of that attribute 1306, an a priori estimate, Pₐₚ, 1310 of the rating, a weighting, Wₐₚ, 1311 for the a priori estimate 1310, a measured click-through rate, Pₘ 1314, and a weighting, Wₘ, 1312 for the measured rate 1314.

The measured click-through rate, Pₘ, 1314 comprises the fraction of users having that attribute value 1308 who have previously “clicked through” from the webpage identified by ID 1304, e.g. the number of users with attribute value 1308 clicking through from the webpage identified by ID 1304, divided by the total number of users with attribute value 1308 who have visited the webpage identified by ID 1304. The a priori estimate, Pₐₚ, 1310 comprises a selected prior prediction of the fraction of users having that attribute value 1308 who will click-through from that page. The respective weightings Wₐₚ, 1311 and Wₘ 1312 define the relative contributions of the a priori estimate, Pₐₚ, and the measured click-through rate to the determined rating.

The controller 60 is adapted to obtain a user profile 300, and a received set ID 1399, identifying a set of webpages.

In operation, the controller 60 uses the received set ID 1399 to retrieve from the direction model data store 66 a direction model having a set ID 1369 which matches the received set ID 1399. The controller 60 then determines a predicted rating for each webpage identifier 1304 of the set 1369 using the predictor 1302 for that webpage identifier.

To determine the predicted rating for a webpage identifier 1304, for each attribute 1306 of the predictor 1302, the controller identifies the attribute value 1308 of the corresponding attribute 1306 in the user profile 300. The controller 60 then uses the attribute value 1308 to obtain from the predictor 1302 the a priori estimate, Pₐₚ, 1310 of the rating, the weighting, Wₐₚ, 1311, the measured click-through rate, Pₘ 1314, and the weighting, Wₘ, 1312.

The controller 60 then determines a predicted rating for the webpage identifier 1304 based on: (a) the a priori estimate, Pₐₚ, 1310 weighted by the weighting, Wₐₚ, 1311; and (b) the measured click-through rate, Pₘ 1314 weighted by the weighting, Wₘ, 1312. For example, the predicted rating may be determined as a function, F, of the measured click-through rate, Pₘ 1314, and the a priori estimate, Pₐₚ, as modified by their respective weightings Wₘ, Wₐₚ, 1311, 1312, viz. predicted rating=F{Wₐₚ.Pₐₚ,Wₘ,Pₘ}.

In the method illustrated in FIG. 5 the user profile 300 is obtained 1100 based on a request for content received at the redirection server in the network of FIG. 3. The direction model 1300 is obtained 1100 based on a webpage identifier received that request for content.

In the method illustrated in FIG. 5, the obtained direction model 1300 comprises a predictor 1302 for each webpage identifier of a set (e.g. the set 69 of FIG. 3). Each predictor 1302 is operable to provide a predicted click-through rate based on the attribute values 1308 of the user profile as described above with reference to FIG. 4.

The obtained direction model 1300 comprises contributions from a selection of attributes 1306 to the predicted ratings for each of a set of webpage identifiers 69. A webpage identifier 1304 is selected 1102 from the direction model 1300. The selected webpage identifier 1304 is used to obtain the predictor 1302 for that webpage identifier 1304 from the direction model 1300.

An attribute 1306 which contributes to the predictor 1302 is selected 1102. The attribute value 1308 of the selected attribute 1306 in the user's profile 300 is used to obtain 1104, 1106 the a priori prediction Pₐₚ, 1310 and its weighting, Wₐₚ, 1311, the measured click-through rate, Pₘ 1314, and its weighting, Wₘ, 1312 from the predictor 1302.

The predicted click-through rate is then determined based on the measured click-through rate, Pₘ 1314, and the a priori estimate, Pₐₚ, as modified by their respective weightings Wₘ, Wₐₚ, 1311, 1312.

It is then determined 1112 whether the contributions from all attributes 1308 in the predictor 1302 have been determined, and in the event that they have not steps 1106 and 1108 are repeated to determine the contributions from each of the attributes 1308 which contribute to the predictor 1302.

Once all of the attributes 1306 which contribute to the predictor 1302 have been taken into account, the contributions from each attribute 1306 are combined 1114 to provide a rating (e.g. a predicted click-through rate) for the webpage identifier 1304.

It is then determined 1114 whether a rating has been determined for all the webpage identifiers 1304 of the direction model 1300. In the event that they have not, the next webpage identifier 1304 of the direction model 1300 is selected 1117, and the steps 1104, 1106, 1108, 1110, 1112, 1113, 1114 are repeated.

Once a rating has been determined for all of the webpage identifiers 1304 of the direction model a webpage identifier 1304 can be selected based on the determined ratings.

The methods and apparatus described with reference to FIG. 4 and FIG. 5 may also be implemented according to the following examples.

In some examples, determining a predicted rating at step 1110 as a function of measured click-through rate, Pₘ 1314, and the a priori estimate, Pₐₚ, 1310, comprises determining the weighted average of Pₘ and Pₐₚ using the respective weightings, Wₘ, Wₐₚ, e.g. the predicted rating may be given by (Wₐₚ Pₐₚ+WₘPₘ)/(Wₐₚ+Wₘ). Other methods of determining a predicted rating based on Pₐₚ and Pₘ may also be used.

In some examples, at step 1114, the ratings from each attribute 1306 are combined 1114 based on the sum of the ratings associated with each attribute 13. For example they may be combined based on their arithmetic mean. The ratings may also be combined by determining the maximum rating associated with any attribute 1306 of the predictor 1302, for example the combined rating for a webpage identifier 1304 may be the maximum rating. The contributions may also be combined by determining the minimum rating associated with any attribute 1306 of the predictor 1302, for example the combined rating may be the minimum rating. The combination 1114 may be based on the product of the ratings, e.g. by multiplying together one or more of the ratings determined at step 1110. For example, the combined rating determined at step 1114 may be based on the geometric mean of one or more of the ratings. The ratings may be combined according to any linear or non-linear method. For example, the rating may be determined by a Bayesian predictor, or a neural network, or any other function of the user profile.

Typically the measured click through rate, Pₘ, comprises the measured number of users clicking through from a webpage divided by the measured number of users who have viewed that webpage. In some examples, the controller 60 is configured to determine the measured number of users who have viewed the page, and in the event that the measured number of users who have viewed the page is less than a selected threshold number, the controller is configured to determine the predicted rating based solely on the a priori estimate, Pₐₚ. This enables users to be directed according to an a priori understanding of their likely interactions with a page until the measured click-through rate is reliably known.

In some examples the relative weightings of the a priori and measured rating, Wₐₚ and Wₘ, are based on the measured number of users who have viewed a page. For example the relative weightings Wₐₚ and Wₘ, associated with a particular value 1308 of an attribute 1306 may be based upon the number of users having that value who have viewed the page. For example the weighting of the measured rating may comprise a term that increases monotonically (e.g. linearly or non-linearly) based on the number of users having that value 1308 who have viewed the page. This enables different weightings to be applied to different parts of the same predictor 1302 dependent upon the sample of the population who have viewed a given webpage.

The total number of users who view have viewed a page, and the click-through rate, may be determined based on requests sent from tags embedded in the identified webpages such as the tag 52 described with reference to FIG. 3. The tags 52, 53, 55, 57, described below with reference to FIG. 9 and FIG. 11 may also be used.

In some examples, where an attribute 1306 defined in a predictor 1300 relates to a continuous variable (e.g. a user's age, or their estimated income) the attribute values 1308 of the predictor may each relate to defined ranges, and the measured click-through rate, Pₘ 1314, the a priori estimate Pₐₚ, and the respective weightings are associated with attribute values in each defined ranges.

The direction models of FIG. 4 and FIG. 5 have been described with reference to a request for content received at the redirection server 16 of FIG. 3. However, direction models according to FIG. 4 and FIG. 5 may also be used with server side redirection as described below with reference to FIG. 11, or with the search provider server described with reference to FIG. 9.

Other direction models may also be used in combination with, or as alternatives to, the direction models described with reference to FIG. 4 and FIG. 5. Operation of one direction model will now be described, by way of example only, with reference to FIG. 6 which illustrates one way of determining a rating for a webpage.

In operation of a direction model, the attribute values of the user profile 300 and the direction model 302 are obtained 304.

It is then determined 306 whether the direction model defines that any attribute values of the user profile are defined by logical conditions in the direction model. In the event that the rating is defined by a logical condition, this defined rating is returned 308 from the direction model.

The direction model may include incremental contributions based on some attributes of the profile. If it is determined that the direction model does not include any incremental contributions the rating value may not be defined, or may be set to a selected default value.

If it is determined 309 that the direction model includes incremental contributions the incremental contribution of each attribute to the rating is determined 310, and the incremental contributions are summed together to determine 312 the rating, and the determined rating is returned 314 from the direction model.

As will be appreciated, the functionality defined in FIG. 6 is just one example of a direction model, and other methods of selecting a webpage identifier may also be used. For example direction models may provide decisions between webpages based on rules which enable a webpage identifier to be selected based on one or more attributes of a user profile. For example, the direction model may select a webpage identifier based on the user profile identifying a user as a member one or more groups.

In some direction models a logical test may define that, in the event an attribute has a selected attribute value, the rating is a pre-selected value so that the webpage associated with that direction model is assigned a particular rating for all users having that attribute value. As an illustrative example, if a user's profile indicates that the “gender” attribute has an attribute value “male” a direction model may provide a selected rating value so that the associated webpage is assigned a particular rating for all male users.

In some cases no logical tests 306, 308, are used and the direction model may be operable to determine a rating based only on incremental contributions associated with the attribute values of a user profile. For example, a direction model may define that an attribute provides an incremental contribution to the rating, in which case the direction model may determine a contribution based on the attribute value of each attribute. These incremental contributions may be defined by weightings or scores assigned to each attribute value of each attribute.

A direction model may define that an attribute provides a rating based on a logical condition and based on incremental contributions to the rating. For example, in the event that an attribute does not have one of a selected set of values, a logical test may fix the rating and in the event that the attribute does have one of the selected set of attribute values the attribute may provide an incremental contribution to the rating based on the attribute value.

Some direction models are configured so that some attributes make only incremental contributions to the rating, some attributes make only logical (preselected) contributions to the rating, and some attributes make contributions based on a logical condition and based on incremental contributions.

These ratings may be provided with reference to any progressive scale which may be symbolic, e.g. numeric, alphanumeric, or non-numeric. Direction models may provide ratings as logical indicators, in which a logical TRUE indicates that the webpage has a rating at one extreme of this progressive scale, and a logical FALSE indicates that the webpage has a rating at another extreme of this progressive scale.

FIG. 7 illustrates one method of operating a redirection server such as the redirection server 16 of FIG. 3. The method of FIG. 7 may be performed by the controller of the redirection server 16 in response to a user clicking a link in a webpage displayed by a user device.

In FIG. 7, a request for content is received 400 from a user device. The request for content includes an identifier associated with a set of stored webpage identifiers, and a user identifier. The set of webpages is determined 402 from the webpage identifier, and the direction model for that set of webpages is obtained.

A user profile is obtained 404 based on the user identifier. The obtained direction model is applied 406, to the user profile—for example as described with reference to FIG. 4 and FIG. 5, to determine a rating for each webpage of the set. Based on the determined ratings, a webpage identifier is selected 408 from the set and a response is provided 410 to the user device from which the request was received at step 404. The response includes the webpage identifier selected based on the ratings, and data configured to cause the user device to provide a new request for the content including the selected webpage identifier.

Once the user device has received the response and generated a new request for content based on that response the user may either (a) click-through to visit a specified webpage (b) click-through to visit another one of a selected number of webpages or (c) “bounce” (e.g. discontinue browsing or visit some other unspecified webpage).

It is then determined 412 whether the user visits a specified “conversion” webpage (e.g. webpage 50 in FIG. 3) including a tag (such as tag 52). In the event that the user visits this page a message is received 413 indicating that the user has visited that webpage. In the event that this message is received 412 the direction model associated with the webpage identifier selected at step 408 is updated to indicate that that webpage identifier successfully led a user having that user's profile to the “conversion” webpage.

In the event that this message is not received, it is determined 414 whether the user device has requested any other tagged webpages from the set of pages associated with the webpage identifier selected at step 408.

In the event that it is determined that the user device has not requested any other tagged webpages within a selected time interval, the direction model associated with the webpage identifier selected at step 408 is updated 416 to indicate that that webpage identifier led the user to “bounce”, (e.g. to leave the site without viewing any other tagged page).

In the event that the user device has requested a further tagged page within a selected time interval, the direction model associated with the webpage identifier selected at step 408 is updated 416 to indicate that that webpage identifier did not lead the user to “bounce” (e.g. to leave the site without viewing any other page). This enables a “bounce rate” to be defined as the proportion of users who view the webpage but then do not go on to request another webpage from a selected set of pages.

FIG. 8 illustrates another method of operating a server in the network of FIG. 3.

In the method shown in FIG. 8, a request for content is received 500, and a set of webpages is identified 502 based on a webpage identifier in the request. The user identifier of the request is used to obtain 504 the attribute values of the user profile, and a webpage identifier is selected 506 from the set of webpage identifiers.

The selected webpage identifier is used to provide 508 a redirect message in response to the request for content

Information is received 510 describing the user interaction with the selected webpage, and based on the received information a direction model associated with the selected webpage is determined 512. It is then determined 514 whether the direction models are complete. In the event that the direction models are complete they are applied to subsequent requests as described with reference to FIGS. 3, 4 and 5 above.

This method may be performed by the controller 60 of the redirect server 16 shown in FIG. 3.

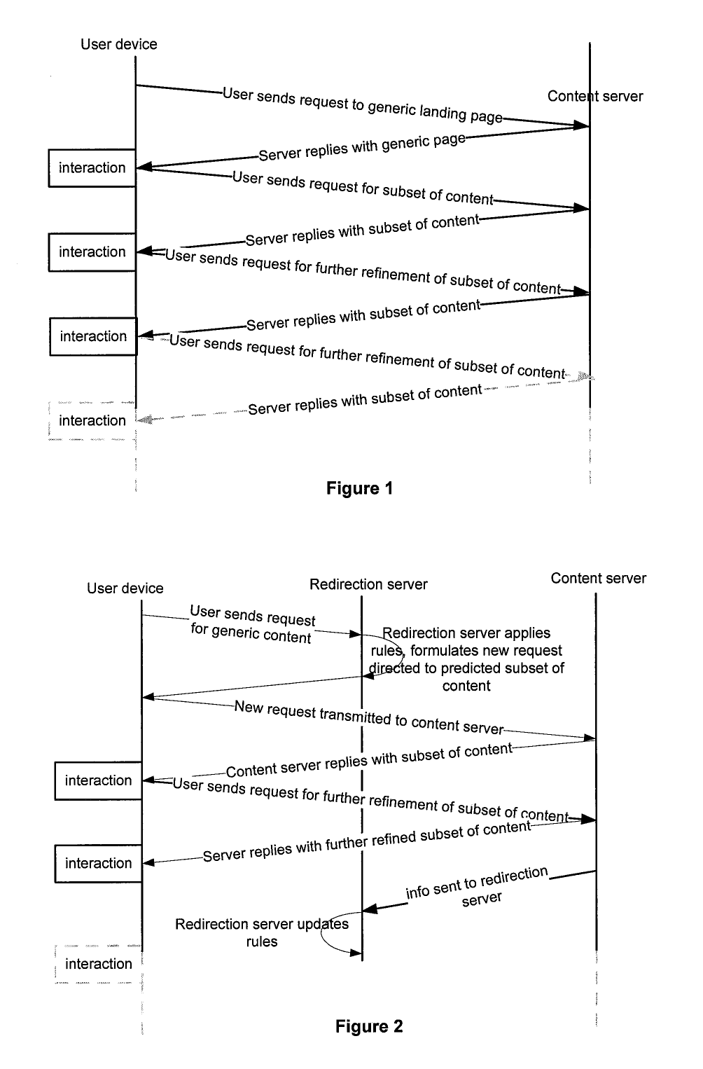

The information received 510 describing the user's interaction with the webpage may comprise an indication as to whether or not the user has provided a further request for content. The information may comprise information about that further request such as whether the user has requested a webpage including a tracking tag (such as tag 52 in FIG. 1). The information may comprise an indication that the user has clicked-through “bounced” e.g. their session has timed out, or they have left the webpage without making any further requests for content.

Determining 512 the direction model comprises modifying the direction model such that the direction model provides a rating that predicts the likelihood with which a user having a selected profile will perform a selected interaction with the website—e.g. the likelihood that the user will click-through, e.g. make a further request for content from the content server 14, or that the user will make a selected request for content (e.g. to select a webpage including a tracking tag, such as tag 52 in FIG. 3).

Selecting 506 a stored webpage may comprise selecting webpage identifiers sequentially from the set 69, e.g. in a round-robin fashion, or according to a random or probabilistic process. The selection 506 may be based on the attribute values of the user's profile and the direction models, for example the selection may be performed so as to make the direction models more complete. In the simplest case this may comprise selecting 506 a webpage that no user has visited previously.

In other cases selecting 506 may comprise storing a frequency distribution of the attribute values of the user profile associated with each previous request, and the webpage to which those requests were redirected. This frequency distribution represents the number of times a user having a particular attribute value had been directed to a particular webpage. Then the webpage identifier can be selected 506 based on this frequency distribution so as to reduce uncertainty (e.g. an estimated prediction error) in the direction models.

Determining 514 that the direction models are complete comprises determining that the direction models have been updated 512 a selected number of times, or that a selected number of requests for content from users having particular attribute values have been received.

The user device 12 may comprise a computing device, such as a personal computer, or a handheld device such as a mobile (cellular) telephone or tablet. Accordingly, the communication interface 20 of the user device 12 may comprise any wired or wireless communication interface such as WI-FI (RTM), Ethernet, or direct broadband internet connection, and/or a GSM, HSDPA, 3GPP, 4G or EDGE communication interface.

A request for content such as request 1 and 3 comprise a message indicating some information that is to be transferred to the user device 12. The request may comprise a method token and an identifier (such as a uniform resource indicator, URI) that identifies the resource upon which to apply the request. The method token indicates the method to be performed on the resource identified by the request. For example these methods may include the hypertext transfer protocol, HTTP, methods “GET” or “HEAD”. The requests for content may be provided in the form of hypertext transfer protocol, HTTP, requests, for example such as those specified in the Network Working Group Request for Comments: RFC 2616. As will be appreciated in the context of the present disclosure, whilst the HTTP protocol and its methods have been used to explain some features of the disclosure other internet protocols, and modifications of the standard HTTP protocol may also be used.

The request 1, 3 also comprises a user identifier for identifying the user 30, and/or the user device 12. The user identifier may be provided by any identifying data. For example the request may include information derived from a cookie 32, or the cookie 32 itself, or the user identifier may be inferred from the request. For example a user identifier may be inferred based on information in the request indicating: a referring website; or the browser 26 application type, operating system of the user device 12, and/or the IP address or email address of the user 30. For example HTTP requests may include an “HTTP-referer” field, or a “From” field, or a “User Agent” field from which a user identifier may be inferred. One particularly useful combination is IP address of the user and the browser application type (e.g. inferred from the “user agent” field of an HTTP request).

A response from the redirect server 16 to the user device 12 may comprise a status line comprising a numeric status code and a location indicator indicating the URL of the content to which the user device 12 is to be redirected. In the example of FIG. 1 the status code indicates that the response from the redirection server is a redirect. This response may be provided in the form of hypertext transfer protocol, HTTP, response and the numeric status code may be any of the status codes for redirection such as 300, 301, 302, 303 or 307.

A webpage comprises a file e.g. a document that is suitable to be accessed on a server over the internet by a web browser, such as the browser 26. The webpage may comprise text for display and other text information or commands which control the formatting of the text when it is displayed to enable the text to be displayed by different devices. Webpages may also comprise metadata describing the form or content of the webpage, this metadata may be provided in the form of a meta tag in the webpage. Webpages may also comprise content that may be constructed by server-side software when the page is requested by the user device. Webpages may also comprise computer programs, sometimes known as client-side scripts, for execution on the user device to make the webpage more responsive to user input.

The link 34 may be a hyperlink which includes a webpage identifier 36 such as a URL and may also comprise some text for the browser to display, and one or more parameters specifying the behaviour of the browser 26 when the link is selected by a user 30.

The controllers 42, 60 of the content server 14 and the redirection server 16 may each be provided by a single processor, which may be dedicated solely to the task of controlling the server. The controllers 42, 60 may also be provided by software running on a computer apparatus which also performs other tasks. In addition, or alternatively, the controllers 42, 60 may be provided by software having components distributed across a number of processors which communicate to provide the functionality ascribed to the controllers 42, 60.

The data stored by the content server 14, and the redirection server 16 such as the webpages 44, 46, 48, 50 and the profile data store 64, the website data store 68, and the direction model data store 66 may be stored on physical media located at a single webserver, and/or the data may be spread across distributed storage systems arranged to be read by the controllers 42, 60 over a network.

The tag 52 may comprise a command embedded in a webpage, such as the webpage 50 of FIG. 1. In order to load the webpage 50, a user device 12 executes the command associated with the tag which sends a message to a destination specified by the command, e.g. to the redirection server 16. This message may comprise a request for content, e.g. a request for a pixel on the page. The message from the tag is configured to enable the receiving device at the destination to identify the page which has been loaded (for example the request can comprise the URL of that page). This enables the receiving device to identify the user who loaded the page, e.g. based on a user ID derived from a cookie in the request. Some or all of the webpages identified by the set of webpage identifiers 69 may comprise a tag 52. This enables the receiving device to determine which pages of the set 69 have been requested by the user device 30. Provided that the messages the tags cause to be sent enable the tagged page to be identified, the tags themselves may be identical.

Client side scripting may be used in addition to, or as an alternative to, the redirection methods described above with reference to FIGS. 2 to 6. In these examples, selective direction of user requests for content is achieved by configuration of the user device 12. The processor 22 of the user device 12 is configured so that, when the user device 12 loads a webpage 28 to be displayed to the user 30, the processor 22 identifies a webpage identifier 36 in the webpage 28, and determines whether the webpage identifier 36 relates to a set of webpage identifiers 69 stored on the redirection server 16. This determination is performed either (a) based on a list of webpage identifiers stored locally on the user device 12, or (b) by sending a request to the redirection server 16 or (c) based on parsing the webpage identifier and applying rules (e.g. string recognition) to determine whether the webpage identifier 36 relates to the set 69.

In the event that the webpage identifier 36 in the webpage 36 does relate to this set of webpages 69, the processor 22 is configured to send a message to the server 16 comprising the webpage identifier 36 and a user identifier of the user 30. The controller 60 of the redirection server 16 is configured to obtain a user profile based on the user identifier, and to obtain a direction model based on the webpage identifier 36 received from the processor 22 of the user device 12. The controller 60 of the redirection server 16 is configured to select a replacement webpage identifier from the set of webpage identifiers 69, and to send the replacement webpage identifier to the processor 22. In response to receiving this replacement webpage identifier, the processor 22 of the user device 12 is configured to amend the link 34 in the webpage 28 by replacing the webpage identifier 36 with the replacement received from the redirection server.

In these examples, configuration of the processor 22 is provided by a computer program, and this computer program may comprise the browser, or an additional computer program considered to cooperate with the browser, such as a “plug-in” or toolbar, or a separate computer program.

The cookie 32 has been described as simply providing a user identifier, however the cookie 32 may comprise some or all of a user profile. For example, the cookie 32 may comprise a plurality of attribute values, each describing an attribute of a user 30 such as their gender, age, location, browser type, income, credit risk, habits, or preferences etc.

Obtaining a user profile comprises retrieving the user profile from a data store, such as the profile data store 64 of FIG. 3, or FIG. 9 to obtain attribute values of the user profile, for example using the cookie 32 to index into a table to retrieve the attribute values for the user identified by that cookie. Obtaining a user profile also comprises reading attribute values of the user from fields of the request such as the cookie 32. Obtaining a user profile also comprises inferring attribute values of the profile from values in the fields of the request, or from the combination of those values. Accordingly, a user profile may be obtained by any one or more of the foregoing possibilities, and these possibilities may also be applied in combination.

FIG. 9 shows a network including a search provider server 16′. In the example of FIG. 9 the search provider server is configured to determine whether a list of search results comprise a result associated with a stored set of web page identifiers 69′, and to select one of the webpage identifiers based on a direction function and the user's profile to amend the list of results. This amendment may replace the result with the selected one of the webpage identifiers before sending the list of results to the user device 12.

In FIG. 3 and FIG. 9 like reference numerals are used to indicate like elements. In FIG. 9 a network 10 comprises a user device 12 coupled to communicate with a content server 14′ and a search provider server 16′ over the internet 100.

The search provider server 16′ comprises a controller 660, a communication interface 62, a profile data store 64, a direction function data store 66, and a website data store 668. The website data store 668 stores a set of webpage identifiers 669 which identify a set of webpages 44, 46, 48 stored on the content server 14′.

The search provider server 16′ is operable to receive a search query 101 from a user device 12, and the controller 660 is configured to determine a user identifier from the search query. The controller 660 is also configured to identify a list of search results based on the search query. Each of these search results typically includes some content that is to be presented to a user, and a webpage identifier.

The controller 660 of the search provider is configured to determine whether the list of search results comprises a result associated with a stored set of webpage identifiers 69. The controller 660 is operable to obtain a direction model for the set of webpages from direction model data store 66, and to select one of the webpage identifiers from the set based on the direction model and the user profile. The controller 660 is further configured to amend the list of search results by introducing the selected webpage identifier into the list of results, and to send the amended list of results 102 to the user device 12. The browser 26 on the user device 12 is configured to display the list of results to the user.

The content server 14′ comprises a communication interface 40 and a controller 42, and data storage for storing a plurality of webpages 44, 46, 48, 50. The content server 12 is configured to receive requests for content and to respond to those requests by sending a webpage identified in the request to the requesting device 12.

Each of the stored webpages 44, 46, 48, 50 is identified by a respective webpage identifier A, B, C, X. The stored webpages 44, 46, 48, 50 each comprise a tag 52, 53, 55, 57. Each tag 52, 53, 55, 57 is configured so that, in order to load the corresponding webpage on a user device 12, the user device 12 is caused to send a request 105 to a server identified by the tag 52, 53, 55, 57. This request may comprise a user identifier, for example the cookie 32. The controller 660 of the search provider server 16′ is configured to receive requests for content from these tags 52, 53, 55, 57.

In the event that the search provider server 16′ receives a request for content from one of these tags, this indicates that the user 30 has selected the inserted result from the list of search results. Accordingly, the controller 660 is configured to update the direction model for the set of webpages 69′ based on requests for content received from these tags 52, 53, 55, 57.

In operation the controller 660 of the search provider server 16′ receives a search query 101 from a user device 12 and provides a list of search results based on the search query 101. Each of these search results typically includes some content that is to be presented to a user, and a webpage identifier. The controller 660 then determines whether the list of search results comprises a result associated with the stored set of webpage identifiers 69.

The controller 660 then determines whether the list of search results comprises a result associated with the stored set webpage identifiers 69. In the event that the list of search results does comprise a result associated with the stored set webpage identifiers, the controller obtains a direction model for the set of webpages from direction model data store 66.

The controller 660 applies the obtained direction model to the user profile to select one of the webpage identifiers from the set 69. The controller 660 then amends the list of results by adding the selected webpage identifier to the list of results before sending the list of results 102 to the user device 12.

Each of the search results in the list of results 102 generally includes some content describing a webpage, and hyperlink to that webpage which includes a webpage identifier. The controller 660 may be configured to insert the selected webpage identifier into the list of results by replacing the webpage identifier in the hyperlink in the results so that, to the user, the list of results appears to be the same, but the included hyperlinks refer to a selected page 44, 46, 48 on the content server 14′.

In the event that the user selects a link from the list of results which refers to one of the webpages 44, 46, 48, 50, the user device 12 sends a request for content 103 to the content server 14. In response to this request for content 103, the content server sends the requested webpage 44 including the corresponding tag 57. The tag 57 is configured so that, in order to load the webpage 44, the user device 12 is caused to transmit a request for content 105 to the search provider's server 105. This enables the search provider server 16′ to determine that the search result that had been inserted into the list of results 102 was selected by a user.

FIG. 10 shows a flow diagram illustrating one method of operating a server in the communications network of FIG. 9.

In FIG. 10 a search query is received 800 from a user device, and the search query includes a user identifier. A list of search results are identified 802 based on the search query 802.

It is then determined 804 whether the list of results includes an item associated with a stored set of webpage identifiers (e.g. the set of webpage identifiers 69′ in FIG. 9). In the event that no such results are identified, the list of results is sent 806 to the user device. In the event that a result is identified which is associated with the stored set of webpage identifiers, a direction model is obtained 808 for that set of webpage identifiers.

The user profile is obtained 810 based on the user identifier in the search query, and the direction model(s) for that page set is(are) applied 812 to the user profile to select a webpage identifier from the set. The selected webpage identifier is added 814 to the list of search results and the amended list of search results is sent 816 to the user device.

In the event that a message is received 818 indicating that the user has requested content using the selected webpage identifier, the direction model for the set of webpages and/or the user profile are updated based on this information. Conversely, in the event that no such message is received 820 within a selected time period the direction model for the set of webpages and/or the user profile are updated based on this information.

The user's request for content 1 may be dealt with by “server side” redirection. This may be implemented by configuring the content server 14 to provide the functionality of the redirect server 16, or vice versa.

FIG. 11 shows an apparatus in which a server side redirect is used to select specific content to service a user request. In FIG. 11 and FIG. 3 like reference numerals are used to identify like elements.

The network of FIG. 11 comprises a selective content server 1016 which comprises a controller 1060. As with the redirection server of FIG. 3, the selective content server comprises a communication interface 62, a profile data store 64, a direction model data store 66, and a website data store 68 which stores a set of webpage identifiers 69. In addition, the selective content server 1016 also comprises a content data store 1017 for storing a plurality of webpages 44, 46, 48, 50. Each of the stored webpages 44, 46, 48, 50 is identified by a respective webpage identifier A, B, C, X. The stored webpages 44, 46, 48, 50 each comprise a tag 52, 53, 55, 57 as described above with reference to FIGS. 3 to 8.

The controller 1060 is configured to receive a request for content 1001 from a user device 12 comprising an identifier of content which is to be provided to the user device. The controller 1060 is configured to compare the identifier with the set of webpage identifiers 69, and is further configured so that, in the event that the identifier in the request corresponds to the set of webpage identifiers 69, the controller obtains a direction model for that set of webpages 69 from the direction model data store 66.

The controller 1060 is also configured to obtain a user profile corresponding to the user 30 based on the request 1001, and to apply the direction model to the user profile according to the methods described above with reference to FIG. 4, FIG. 5, FIG. 6 and FIG. 7. Based on the direction model and the user profile, the controller 1060 selects content from the content data store 1014 and sends the selected content to the user device 12 in a response 1002 to the request 1001.

The controller 1060 is also configured to determine and/or update the direction models by monitoring the interaction of the user 30 with the webpages 44, 46, 48, 50 using the tags 52, 53, 55, 57 as described above with reference to steps 412 to 418 of FIG. 7, and with reference to FIG. 8.

A direction model may be configured to provide a rating for each webpage of the set 69, 69′, or simply to select a webpage identifier from the set. In some examples a direction model is provided for each webpage of the set 69, 69′, and in some examples a single direction model is provided for the set.

In the embodiment of FIG. 9, the search provider server 16′ is configured to apply the direction model to update the list of search results. However, the search provider server 16′ may be configured to identify an item in the list of results which relates to a stored set of webpages, and to replace the webpage identifier in that item of the results with a webpage identifier, such as the webpage identifier 36 of FIG. 3 that refers to a redirection server 16 such as that shown in FIG. 3.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings.

Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in not-transitory form. Hardware includes computers, handheld devices, programmable processors, general purpose processors, application specific integrated circuits, ASICs, field programmable gate arrays, FPGAs, arrays of logic gates.

Other examples and variations of the disclosure will be apparent to the skilled reader in the context of the present disclosure.

What is claimed is:

1. An apparatus comprising:
a data store configured to store a plurality of webpage identifiers each identifying a different webpage of a set of webpages;
a communication interface configured to receive a request for content to be provided at a user device; and
a controller configured to:
determine a user identifier of a user of the user device;
obtain a user profile based on the user identifier;
select one of the stored webpage identifiers based on the user profile and a direction model; and
redirect the request according to the selected webpage identifier.

2. The apparatus of claim 1 wherein the direction model comprises a plurality of predictors, each predictor is configured to provide a predicted rating for a corresponding one of the stored webpage identifiers, wherein each predictor is configured to provide a predicted rating for a corresponding webpage identifier based on at least one attribute value of the user profile.

3. The apparatus of claim 2 wherein each predictor comprises at least one of an estimate of the rating and a measured rating, corresponding to each of the at least one attribute values, in which at least one of the predictors comprises both an estimate of the rating and a measured rating, and the controller is configured to determine the predicted rating based on a combination of the estimate of the rating and the measured rating.

4. The apparatus of claim 3 in which controller is configured to combine the estimate of the rating with the measured rating according to a selected weighting, and in which the controller is configured to determine the weighting based on a number of users that have visited a webpage identified by the webpage identifier associated with the at least one predictor.

5. The apparatus of claim 1 in which the controller is configured to receive an indication of the user's interaction with a webpage identified by the selected webpage identifier, and to modify the direction model based on the received indication.

6. The apparatus of claim 5 in which receiving an indication comprises receiving a second request for content from the user device indicating that the user has requested content from one of a second selected set of webpages.

7. An apparatus comprising:
a data store configured to store a plurality of webpage identifiers each identifying a different webpage of a set of webpages;
a communication interface configured to receive a request for content to be provided at a user device; and
a controller configured to:
determine a user identifier of a user of the user device;
select one of the stored webpage identifiers;
redirect the request according to the selected webpage identifier;
receive, via the communication interface, information describing the user's interaction with a webpage identified by the selected webpage identifier;
obtain a user profile based on the user identifier;
determine a direction model associated with the set of webpages based on the user profile and the information describing the user's interaction with the webpage.

8. The apparatus of claim 7 in which selecting a webpage identifier comprises at least one of: selecting according to a sequence of webpage identifiers; selecting based on a previous selection; selecting according to a random process; and selecting according to a probability distribution; and selecting based on a number of users that have visited each of the webpages identified by the stored webpage identifiers.

9. The apparatus of claim 7 in which the controller is configured to select one of the stored webpage identifiers based on an attribute value of the user profile and a number of users having a user profile comprising the attribute value that have visited each webpage of the set.

10. The apparatus of claim 7 in which the controller is further configured such that, in the event that a selected number of requests for content have been redirected, the controller is configured to select one of the stored webpage identifiers based on the user profile and a direction model; and to redirect the request according to the selected webpage identifier.

11. The apparatus of claim 7, in which the set of webpages comprises a default webpage, and a plurality of alternative webpages;
and the controller is configured to determine a first rating associated with the default webpage;
determine a second rating associated with a selected alternative webpage; and
redirect the request to either the selected alternative page or to the default page based on the first and second ratings.

12. A method comprising;
receiving a request for content to be provided at a user device; and
determining a user identifier of a user of the user device;
obtaining a user profile based on the user identifier;
selecting a webpage identifier from a plurality of stored webpage identifiers based on the user profile and a direction model, wherein each of the stored webpage identifiers identifies a different webpage of a set of webpages; and
redirecting the request according to the selected webpage identifier.

13. The method of claim 12 in which selecting one of the stored webpage identifiers comprises selecting a webpage identifier based on the direction model and an attribute value of the user profile.

14. The method of claim 12 comprising selecting the direction model from a plurality of stored direction models based on a webpage identifier in the received request for content.

15. The method of claim 12 in which the direction model comprises a plurality of predictors, each predictor being configured to provide a predicted rating for a corresponding one of the stored webpage identifiers, the method comprising determining a predicted rating for each of the stored webpage identifiers based on the predictors and at least one attribute value of the user profile.

16. The method of 12 comprising receiving an indication of the user's interaction with a webpage identified by the selected webpage identifier, and modifying the direction model based on the received indication.

17. A method comprising:
receiving a network message comprising a search query from a user device;
determining a user identifier identifying a user of the user device based on information associated with the search query;
identifying a list of search results based on the search query;
determining whether the list of search results comprises a result associated with a stored plurality of webpage identifiers;
sending the list of search results to the user device; and,
in the event that it is determined that the list of search results comprises a result associated with the stored plurality of webpage identifiers:
obtaining a user profile based on the user identifier;
obtaining a direction model associated with the set of webpages;
selecting a webpage identifier from the stored plurality of webpage identifiers based on the user profile and the direction model; and
amending the list of results by adding the selected webpage identifier to the list of results before sending the list of results to the user device.

18. The method of claim 17 comprising receiving a second network message indicating that the webpage identified by the selected webpage identifier has been sent to the user device; and modifying the direction model based on the second network message.

19. The method of claim 18 in which the direction model comprises a predictor for each webpage identifier of the set to provide a rating for each webpage of the set based on the user profile, the method comprising selecting the webpage identifier based on the provided ratings.

20. The method of claim 19 in which the set of webpages comprises a default webpage, and a plurality of alternative webpages, the method comprising determining a first rating associated with the default webpage;
determining a second rating associated with a selected alternative webpage; and
selecting the alternative page or the default page based on the first and second ratings.
